(19) United States
(12) Patent Application Publication
(10) Pub. No.: US 2026/0089456 A1
(43) Pub. Date: Mar. 26, 2026

(54) SPATIAL SOUND GENERATION FOR MIXED REALITY APPLICATIONS

(71) Applicant: Meta Platforms Technologies, LLC, Menlo Park, CA (US)

(72) Inventors: Varun Kumar Nagaraja, San Jose, CA (US); Gael Le Lan, Rennes (FR); Christopher Barth, Seattle, WA (US); Zhaoheng Ni, Jersey City, NJ (US); Yangyang Shi, Bellevue, WA (US); Remi Audfray, San Francisco, CA (US); Eric Van Amerongen, Seattle, WA (US); Viktor Phoenix, Los Angeles, CA (US); Tarun Pruthi, Fremont, CA (US); Sean Kasimir Vora, Fremont, CA (US)

(21) Appl. No.: 19/072,896

(22) Filed: Mar. 6, 2025

Related U.S. Application Data
(60) Provisional application No. 63/697,395, filed on Sep. 20, 2024.

(51) Int. Cl. H04S 7/00; G06F 40/40; H04S 3/00

(52) U.S. Cl. CPC H04S 7/302; G06F 40/40; H04S 3/008; H04S 2400/01; H04S 2400/11

(57) ABSTRACT

As disclosed herein, a computer-implemented method for audio generation in mixed reality environments is provided. The method may include determining, based on a description of a soundscape of a mixed reality environment, a first prompt for a continuous audio signal associated with the soundscape and a second prompt for an intermittent audio signal associated with the soundscape. The method may include providing the first and second prompts to a model configured to determine at least one audio signal based on a prompt describing the audio signal. The method may include generating, by the model, a continuous audio signal and an intermittent audio signal. The method may include combining the continuous audio signal and the intermittent audio signal to generate a composite audio signal. The method may include rendering the composite audio signal in the mixed reality environment. A system and a non-transitory computer-readable storage medium are also disclosed.

### CROSS-REFERENCE TO RELATED APPLICATIONS

The present application claims the benefit of priority under 35 U.S.C. § 119 from U.S. Provisional patent Application Ser. No. 63/697,395 entitled “SPATIAL AMBIENT SOUND GENERATION FROM A TEXT PROMPT,” filed on Sep. 20, 2024, the disclosure of which is hereby incorporated by reference in its entirety for all purposes.

### BACKGROUND

### Field

The present disclosure generally relates to sound generation for mixed reality environments. More particularly, the present disclosure relates to spatial audio generation from text prompts.

### Related Art

The evolution of mixed reality (MR) technologies has brought about transformative changes in how users interact with digital and physical worlds. As these environments become increasingly sophisticated, the need for compelling auditory experiences to complement the visual elements becomes more apparent. In particular, the creation of dynamic, contextually appropriate soundscapes, wherein sounds are not merely static audio cues but rather adapt to the real-time surroundings, actions, or requests of a user, remains a significant challenge in mixed reality systems.

A soundscape of a digital environment typically refers to a composition of various environmental sounds that help create the atmosphere and convey the nature of a given setting. A soundscape may include ambient sounds like wind, wildlife, machinery, or traffic, or a soundscape may include specific actions or interactions, such as footsteps, object movements, or user-driven events. In traditional audio production for digital environments, soundscapes are typically pre-designed and do not adjust in real time to the environment, behavior, or request of a user. While such pre-recorded soundscapes are effective in static environments, they fall short in mixed reality applications where dynamic, immersive auditory experiences are crucial to enhancing user interaction.

### SUMMARY

The subject disclosure provides for systems and methods for generating immersive, real-time soundscapes for mixed reality environments based on user prompts describing the desired auditory setting.

According to certain aspects of the present disclosure, a computer-implemented method for audio generation in mixed reality environments is provided. The computer-implemented method may include receiving a description of a soundscape of a mixed reality environment. The computer-implemented method may include determining, based on the description, a first prompt for a continuous audio signal associated with the soundscape and a second prompt for an intermittent audio signal associated with the soundscape. The computer-implemented method may include providing the first prompt and the second prompt to a model configured to determine at least one audio signal based on a prompt describing the audio signal. The computer-implemented method may include generating, by the model, at least one continuous audio signal based on the first prompt and at least one intermittent audio signal based on the second prompt. The computer-implemented method may include combining the at least one continuous audio signal and the at least one intermittent audio signal to generate a composite audio signal representing the soundscape of the mixed reality environment. The computer-implemented method may include rendering the composite audio signal in the mixed reality environment.

According to another aspect of the present disclosure, a system is provided. The system may include one or more processors. The system may include a memory storing instructions that, when executed by the one or more processors, cause the system to perform operations. The operations may include receiving a description of a soundscape of a mixed reality environment. The operations may include determining, based on the description, a first prompt for a continuous audio signal associated with the soundscape and a second prompt for an intermittent audio signal associated with the soundscape. The operations may include providing the first prompt and the second prompt to a model configured to determine at least one audio signal based on a prompt describing the audio signal. The operations may include generating, by the model, at least one continuous audio signal based on the first prompt and at least one intermittent audio signal based on the second prompt. The operations may include combining the at least one continuous audio signal and the at least one intermittent audio signal to generate a composite audio signal representing the soundscape of the mixed reality environment. The operations may include rendering the composite audio signal in the mixed reality environment.

According to yet other aspects of the present disclosure, a non-transitory computer-readable storage medium storing instructions encoded thereon that, when executed by a processor, cause the processor to perform operations, is provided. The operations may include receiving a description of a soundscape of a mixed reality environment. The operations may include determining, based on the description, a first prompt for a continuous audio signal associated with the soundscape and a second prompt for an intermittent audio signal associated with the soundscape. The operations may include determining a first variation parameter associated with the first prompt and a second variation parameter associated with the second prompt. The operations may include providing the first prompt, the second prompt, the first variation parameter, and the second variation parameter to a model configured to determine at least one audio signal based on a prompt describing the audio signal. The operations may include generating, by the model, a plurality of continuous audio signals based on the first prompt and the first variation parameter, and a plurality of intermittent audio signals based on the second prompt and the second variation parameter. The operations may include combining the plurality of continuous audio signals and the plurality of intermittent audio signals to generate a composite audio signal representing the soundscape of the mixed reality environment. The operations may include determining a first plurality of positions for the plurality of continuous audio signals within the mixed reality environment. The plurality of continuous audio signals may be a same radial distance from a user in the mixed reality environment, and each continuous audio signal of the plurality of continuous audio signals may be circumferentially equidistant from a next continuous audio signal of the plurality of continuous audio signals. The operations may include determining a second plurality of positions for the plurality of intermittent audio signals within the mixed reality environment. Two or more of the plurality of intermittent audio signals may be a different radial distance from the user in the mixed reality environment and may be non-equidistant from each other. The operations may include rendering, based on the first plurality of positions and the second plurality of positions, the composite audio signal in the mixed reality environment.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example environment suitable for generating spatial audio from a text-based description of a soundscape, according to some embodiments;

FIG. 2 is a block diagram illustrating details of an example client device and an example server from the example environment of FIG. 1, according to some embodiments;

FIG. 3 illustrates an example view of a mixed reality environment from a perspective of a user of the mixed reality environment, according to some embodiments;

FIG. 4 illustrates steps in a process for generating spatial audio from a text-based prompt describing a landscape or a soundscape of a mixed reality environment, according to some embodiments;

FIG. 5 illustrates example individual audio signals, including continuous audio signals and intermittent audio signals, associated with a mixed reality environment, according to some embodiments;

FIG. 6 illustrates example positionings of continuous audio signals and intermittent audio signals in a mixed reality environment, according to some embodiments;

FIG. 7 is a flowchart illustrating operations in a method for generating spatial audio from a text-based prompt describing a landscape or a soundscape of a mixed reality environment, according to some embodiments; and

FIG. 8 is a block diagram illustrating an exemplary computer system with which client devices, and the steps or operations in FIGS. 4 and 7, may be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive. Those skilled in the art may realize other elements that, although not specifically described herein, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### General Overview

The evolution of mixed reality (MR) technologies has brought about transformative changes in how users interact with digital and physical worlds. As these environments become increasingly sophisticated, the need for compelling auditory experiences to complement the visual elements becomes more apparent. In particular, the creation of dynamic, contextually appropriate soundscapes, wherein sounds are not merely static audio cues but rather adapt to the real-time surroundings, actions, or requests of a user, remains a significant challenge in mixed reality systems.

A soundscape of a digital environment typically refers to a composition of various environmental sounds that help create the atmosphere and convey the nature of a given setting. A soundscape may include ambient sounds like wind, wildlife, machinery, or traffic, or a soundscape may include specific actions or interactions, such as footsteps, object movements, or user-driven events. In traditional audio production for digital environments, soundscapes are typically pre-designed and do not adjust in real time to the environment, behavior, or prompt of a user. While such pre-recorded soundscapes are effective in static environments, they fall short in mixed reality applications where dynamic, immersive auditory experiences are crucial to enhancing user interaction.

For example, in a mixed reality application, a user may experience a jungle environment. As the user moves closer to a river, the sound of flowing water may become more prominent, or as the user moves farther from a nearby animal, the sound of the animal may become less prominent. Similarly, a user may interact with virtual objects or characters that produce contextual sounds, such as the creak of a door when opened or the rustle of leaves when touched. Generating such rich, interactive soundscapes is a complex process, requiring systems that not only create realistic audio but also do so in real time and in response to user prompts.

Existing solutions for generating soundscapes for MR applications are primarily based on pre-recorded audio files or sound libraries, which are triggered by specific events, user actions, or environmental factors. These solutions, while functional, are limited in their ability to produce truly dynamic and context-specific sound environments, particularly in situations where a highly tailored soundscape needs to be generated on demand, based on a user prompt. The inability to create rich, fully responsive soundscapes directly from user descriptions limits the potential for more adaptive, user-driven MR experiences.

As disclosed herein, novel systems and methods provide for generating immersive, real-time soundscapes based on natural language inputs describing a desired auditory environment. A description of a desired soundscape may be analyzed, and environmental sounds, spatial positioning, and interactive audio components may be synthesized to create a coherent, dynamic auditory experience. The disclosed technology may enable soundscapes to be tailored not only to the immediate surroundings and actions of a user but also to broader environmental conditions and changes. Furthermore, the system may ensure that a generated soundscape is contextually responsive, adapting dynamically as a user interacts with and moves through an MR environment.

According to some embodiments, a description of a soundscape may include a text-based description. By enabling the creation of soundscapes from text-based descriptions, the disclosed technology may provide a more flexible and scalable approach to audio design in MR, affording new possibilities for a wide range of applications, including gaming, training simulations, interactive storytelling, educational tools, and so on. The ability to generate soundscapes in real time based on natural language inputs may dramatically enhance user immersion and engagement, making the auditory experience of MR environments richer, more personalized, and more deeply integrated with the actions and experiences of a user.

### Terminology

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real world. For example, an AR headset could be shaped as a pair of glasses with a pass-through display, which allows light from the real world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

### Example System Architecture

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments may be practiced without these specific details. In other instances, well known structures and devices are shown in block diagram form in order to facilitate a description thereof. The intention is to cover all modifications, equivalents, and alternatives consistent with the claimed subject matter.

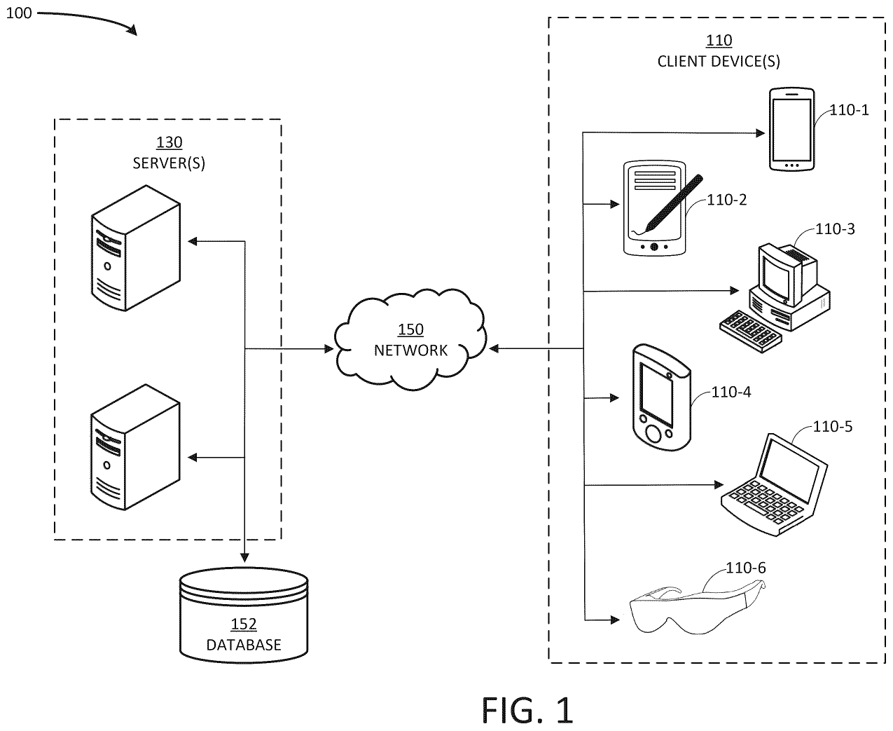

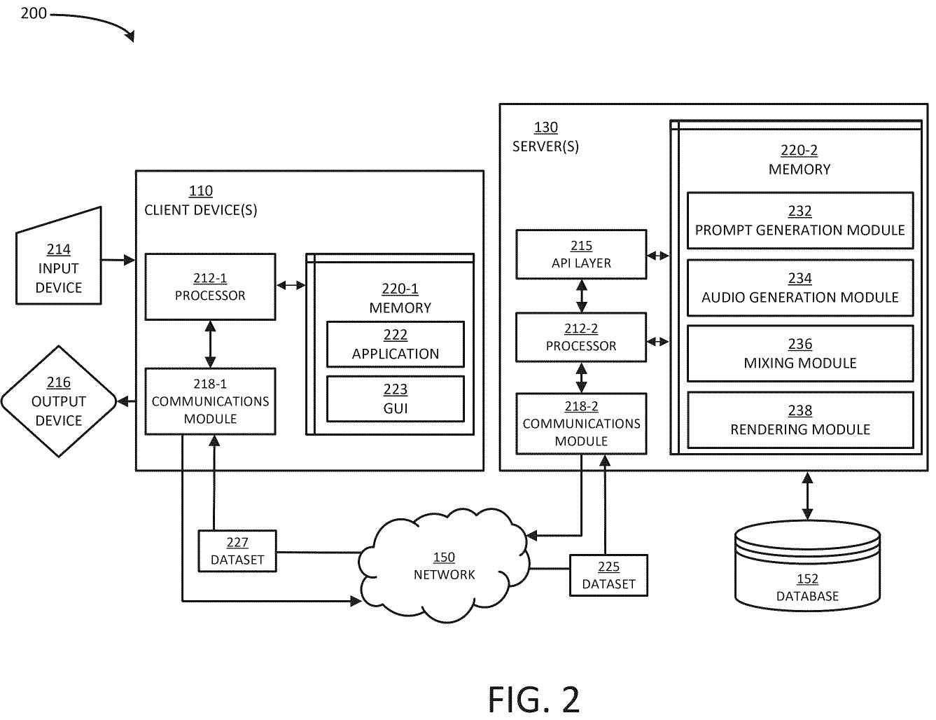

FIG. 1 illustrates an example environment 100 suitable for generating spatial audio from a text-based description of a soundscape, according to some embodiments. Environment 100 may include server(s) 130 communicatively coupled with client device(s) 110 and database 152 over network 150. One of server(s) 130 may be configured to host a memory including instructions which, when executed by a processor, cause server(s) 130 to perform at least some of the steps in methods as disclosed herein. In some embodiments, the processor may be configured to control a graphical user interface (GUI) for the user of one of client device(s) 110 accessing a prompt generation module (e.g., prompt generation module 232, FIG. 2), an audio generation module (e.g., audio generation module 234, FIG. 2), a mixing module (e.g., mixing module 236, FIG. 2), or a rendering module (e.g., rendering module 238, FIG. 2). Accordingly, the processor may include a dashboard tool, configured to display components and graphic results to the user via a GUI (e.g., GUI 223, FIG. 2). For purposes of load balancing, multiple servers of server(s) 130 may host memories including instructions to one or more processors, and multiple servers of server(s) 130 may host a history log or database 152 including multiple training archives for the prompt generation module, the audio generation module, the mixing module, or the rendering module. Moreover, in some embodiments, multiple users of client device(s) 110 may access the same prompt generation module, audio generation module, mixing module, or rendering module. In some embodiments, a single user with a single client device (e.g., one of client device(s) 110) may provide images and data (e.g., text) to train one or more artificial intelligence (AI) models running in parallel in one or more server(s) 130. Accordingly, client device(s) 110 and server(s) 130 may communicate with each other via network 150 and resources located therein, such as data in database 152.

Server(s) 130 may include any device having an appropriate processor, memory, and communications capability for a prompt generation module, an audio generation module, a mixing module, or a rendering module. Any of the prompt generation module, the audio generation module, the mixing module, or the rendering module may be accessible by client device(s) 110 over network 150.

Client device(s) 110 may include any one of a laptop computer 110-5, a desktop computer 110-3, or a mobile device, such as a smartphone 110-1, a palm device 110-4, or a tablet device 110-2. In some embodiments, client device(s) 110 may include a headset or other wearable device 110-6 (e.g., a mixed reality (MR) headset, smart glass, or head-mounted display (HMD), including a virtual reality (VR), augmented reality (AR), or extended reality (XR) headset, smart glass, or HMD), such that at least one participant may be running a mixed reality application-including a virtual reality application, an augmented reality application, or extended reality application-installed therein.

Network 150 may include, for example, any one or more of a local area network (LAN), a wide area network (WAN), the Internet, and the like. Further, network 150 may include, but is not limited to, any one or more of the following network topologies, including a bus network, a star network, a ring network, a mesh network, a star-bus network, tree or hierarchical network, and the like.

A user may own or operate client device(s) 110 that may include a smartphone device 110-1 (e.g., an IPHONE® device, an ANDROID® device, a BLACKBERRY® device, or any other mobile computing device conforming to a smartphone form). Smartphone device 110-1 may be a cellular device capable of connecting to a network 150 via a cell system using cellular signals. In some embodiments and in some cases, smartphone device 110-1 may additionally or alternatively use Wi-Fi or other networking technologies to connect to network 150. Smartphone device 110-1 may execute a client, Web browser, or other local application to access server(s) 130.

A user may own or operate client device(s) 110 that may include a tablet device 110-2 (e.g., an IPAD® tablet device, an ANDROID® tablet device, a KINDLE FIRE® tablet device, or any other mobile computing device conforming to a tablet form). Tablet device 110-2 may be a Wi-Fi device capable of connecting to a network 150 via a Wi-Fi access point using Wi-Fi signals. In some embodiments and in some cases, tablet device 110-2 may additionally or alternatively use cellular or other networking technologies to connect to network 150. Tablet device 110-2 may execute a client, Web browser, or other local application to access server(s) 130.

The user may own or operate client device(s) 110 that may include a laptop computer 110-5 (e.g., a MAC OS® device, WINDOWS® device, LINUX® device, or other computer device running another operating system). Laptop computer 110-5 may be an Ethernet device capable of connecting to a network 150 via an Ethernet connection. In some embodiments and in some cases, laptop computer 110-5 may additionally or alternatively use cellular, Wi-Fi, or other networking technologies to connect to network 150. Laptop computer 110-5 may execute a client, Web browser, or other local application to access server(s) 130.

FIG. 2 is a block diagram 200 illustrating example client device(s) 110 and example server(s) 130 from the environment of FIG. 1, according to some embodiments. Client device(s) 110 and server(s) 130 may be communicatively coupled over network 150 via respective communications modules 218-1 and 218-2 (hereinafter, collectively referred to as “communications modules 218”). Communications modules 218 may be configured to interface with network 150 to send and receive information, such as requests, responses, messages, and commands to other devices on the network in the form of datasets 225 and 227. Communications modules 218 may be, for example, modems or Ethernet cards, and may include radio hardware and software for wireless communications (e.g., via electromagnetic radiation, such as radiofrequency (RF), near field communications (NFC), Wi-Fi, or Bluetooth radio technology). Client device(s) 110 may be coupled with input device 214 and with output device 216. Input device 214 may include a keyboard, a mouse, a pointer, a touchscreen, a microphone, a joystick, a virtual joystick, and the like. In some embodiments, input device 214 may include cameras, microphones, and sensors, such as touch sensors, acoustic sensors, inertial motion units (IMUs), and other sensors configured to provide input data to an MR headset or head-mounted display (HMD) (including a VR, AR, or XR headset or HMD). For example, in some embodiments, input device 214 may include an eye-tracking device to detect the position of a pupil of a user in an MR headset or HMD. In some embodiments, input device 214 may include a head-tracking device to detect the position of a head of a user in an MR headset or HMD. Likewise, output device 216 may include a display and a speaker with which the customer may retrieve results from client device(s) 110. Client device(s) 110 may also include processor 212-1, configured to execute instructions stored in memory 220-1, and to cause client device(s) 110 to perform at least some of the steps or operations in processes or methods consistent with the present disclosure. Memory 220-1 may further include application 222 and graphical user interface (GUI) 223, configured to run in client device(s) 110 and couple with input device 214 and output device 216. Application 222 may be downloaded by the user from server(s) 130 or may be hosted by server(s) 130. In some embodiments, client device(s) 110 may be an MR headset or HMD (including a VR, AR, or XR headset or HMD), and application 222 may be an MR application, such as a VR, AR, or XR application. In some embodiments, client device(s) 110 may be a mobile phone used to collect a video or picture and upload to server(s) 130 using a video or image collection application (e.g., application 222), to store in database 152. In some embodiments, application 222 may run on any operating system (OS) installed in client device(s) 110. In some embodiments, application 222 may run out of a Web browser, installed in client device(s) 110.

Dataset 227 may include multiple messages and multimedia files. A user of client device(s) 110 may store at least some of the messages or data content in dataset 227 in memory 220-1. In some embodiments, a user may upload, with client device(s) 110, dataset 225 onto server(s) 130. Database 152 may store data and files associated with application 222 (e.g., one or more of datasets 225 and 227).

Server(s) 130 may include application programming interface (API) layer 215, which may control application 222 in each of client device(s) 110. Server(s) 130 may also include memory 220-2 storing instructions which, when executed by processor 212-2, cause server(s) 130 to perform at least partially one or more steps or operations in processes or methods consistent with the present disclosure.

Processors 212-1 and 212-2 and memories 220-1 and 220-2 will be collectively referred to, hereinafter, as “processors 212” and “memories 220,” respectively.

Processors 212 may be configured to execute instructions stored in memories 220. In some embodiments, memory 220-2 may include prompt generation module 232, audio generation module 234, mixing module 236, or rendering module 238. Prompt generation module 232, audio generation module 234, mixing module 236, or rendering module 238 may share or provide features or resources to GUI 223, including any tools or modules associated with a mixed reality application (e.g., application 222). A user may access prompt generation module 232, audio generation module 234, mixing module 236, or rendering module 238 through application 222, installed in memory 220-1 of client device(s) 110. Accordingly, application 222, including GUI 223, may be installed by server(s) 130 and perform scripts and other routines provided by server(s) 130 through any one of multiple tools. Execution of application 222 may be controlled by processor 212-1.

Prompt generation module 232 may be configured to accept a natural language description of a landscape or soundscape of a mixed reality environment and to generate text-based descriptions of continuous or intermittent sounds characteristic of the landscape or soundscape. A user may provide the natural language description (e.g., via text, speech, or the like), and the text-based descriptions of the continuous or intermittent sounds may be used as prompts for creating corresponding audio signals.

Prompt generation module 232 may enable a user to provide, via a user interface, a natural language description of a mixed reality environment. By way of non-limiting examples, the natural language description may include descriptions of audio elements or events (e.g., storm, wind, thunder, crashing waves, rustling leaves, heavy machinery) or may include descriptions of visual elements or events (e.g., mountain, beach, forest, airport terminal, roadway intersection, grocery store) of the mixed reality environment. By way of non-limiting examples, a user may specify characteristics such as time of day (e.g., morning, evening), weather (e.g., sunny, rainy, windy), or geographical location (e.g., desert, forest, city). A user may specify characteristics such as the layout of the mixed reality environment, such as distances, sizes, or relative positioning of objects and entities within the space. A user may specify actions or interactions the user expects to occur within the environment (e.g., walking near a stream, approaching a waterfall).

Prompt generation module 232 may populate a template with instructions for guiding the processing or output of an artificial intelligence (AI) model (e.g., a machine learning (ML) model, such as a large language model (LLM)). The instructions may include the natural language description provided by the user (e.g., “Afternoon in a high-tech laboratory with whirring machinery and glowing instruments”). By way of non-limiting examples, the instructions may include the following: “Provide a list of descriptions of sounds most commonly heard in an environment described by, ‘Afternoon in a high-tech laboratory with whirring machinery and glowing instruments.’” “Each description should correspond to a sound originating from a single source.” “Do not include high-pitched sounds.” “Do not include harsh sounds.” “A list of examples of sound descriptions may include ‘water current flowing, soft, gentle,’ ‘ocean waves, muffled,’ ‘flutter of bird's wings, fleeting.’” “Categorize the sound descriptions as continuous sounds or intermittent sounds.”

In some embodiments, prompt generation module 232 may pass the template, including the natural language description and other instructions, to a large language model (LLM). The LLM may be trained to understand and interpret complex language structures, including specific environmental and auditory cues. The LLM processes may include the following: natural language understanding, contextual interpretation, and sound category identification. Using natural language understanding, the LLM may extract key features of the natural language description, such as geographic details, dynamic activities, or environmental conditions. The LLM may understand terms related to sound sources, behaviors of sound sources, or spatial relationships within the environment (e.g., “distant thunder,” “rustling leaves,” “footsteps passing”). Using contextual interpretation, the LLM may use the environmental parameters or spatial layout to infer how such elements in the mixed reality environment (e.g., virtual or physical furniture) should interact with the generated sounds. The LLM may consider factors such as setting (e.g., indoors or outdoors), proximity (nearby or distant sounds), time-based changes (e.g., sounds changing from day to night), or weather conditions (e.g., wind affecting sound propagation). Using sound category identification, the LLM may categorize sounds based on template inputs, distinguishing between continuous sounds (e.g., a flowing river, wind in trees) and intermittent sounds (e.g., birds chirping, footsteps). The LLM may identify continuous or intermittent sound types by interpreting both the environmental context and spatial aspects.

Based on the template, the LLM may generate text-based descriptions of sounds that are commonly present in the mixed reality environment. The LLM may classify the sounds into two categories: continuous sounds and intermittent sounds. Continuous sounds may include sounds that maintain a steady presence in the mixed reality environment and do not have a defined start or end. Non-limiting examples of continuous sounds may include the following: hiss of ventilation system, hum of florescent lights, flowing stream, wind blowing across an open field, distant thunder, or rain falling on a roof. Intermittent sounds may include sounds triggered by specific actions, events, or conditions within the mixed reality environment, and may typically have a start and an end time. Non-limiting examples of intermittent sounds may include the following: beep of computer terminal, gurgling of liquid pump, birds chirping, footsteps receding, rustle of small creatures in an underbrush, distant conversation, or footsteps on gravel.

Based on the spatial layout provided by the user or interpreted by the LLM, the LLM may assign appropriate spatial attributes to each sound. For continuous or intermittent sounds, the LLM may output detailed descriptions that characterize a positioning, movement, or dynamic change of the sounds within the mixed reality environment. Spatial attributes may include directionality, distance, volume, doppler effect, or environmental interaction. Directionality may include a relative position of the sound source (e.g., left, right, behind, above). Distance may include a proximity of sound sources to the user (e.g., far-off, nearby, or at an exact location of the user). Volume may include loudness of the sound depending on the relative distance of the user to the source. Doppler effect may include adjustments to the pitch or tone of sounds as the sounds move relative to the user. Environmental interaction may include how a sound should behave in relation to other digital or physical objects (e.g., echoes off walls or the muffling effect of a forest canopy).

After processing the text-based descriptions and spatial attributes, the LLM may output a comprehensive set of text-based descriptions of sounds associated with the mixed reality environment. The text-based descriptions may include descriptions of continuous sounds, with spatial and dynamic parameters (e.g., “a rapid river running fifty meters to the right”). The text-based descriptions may include descriptions of intermittent sounds, including timing, frequency, or user interaction cues (e.g., “footsteps of a person walking on gravel ten meters away, with a slight echo effect”). In some embodiments, a text-based description may include an identifier for whether the text-based description is associated with a continuous sound or with an intermittent sound. In some embodiments, a text-based description may include a length of the soundscape associated with a text-based description. The set of text-based descriptions may be used as prompts for creating audio corresponding to each text-based description.

Audio generation module 234 may be designed to dynamically generate audio from text-based descriptions of the audio. Using an AI model (e.g., an ML model, such as a text-to-audio model), audio generation module 234 may accept a natural language prompt for an individual sound, process the prompt, and generate multiple variations of audio corresponding to the prompt. A variation parameter may be provided to the AI model to allow for subtle or more pronounced differences in the variation of the generated audio, depending on the value of the parameter.

In some embodiments, audio generation module 234 may use a text-to-audio model to take a text-based input prompt and generate an audio signal corresponding to the sound described by the prompt. The text-to-audio model may use deep learning techniques or neural networks to map textual descriptions to audio features, such as timbre, frequency, or dynamic characteristics (e.g., volume, modulation). The text-to-audio model may generate a reference audio signal that may correspond to a prompt. The sound characteristics (e.g., pitch, volume, timbre, spatial positioning) of the reference audio signal may be encoded into a vector space. Based on, for example, spherical interpolation techniques, the text-to-audio model may compute a series of variations of the reference audio signal by interpolating between vectors representing different possible states of the sound (e.g., wind blowing gently, wind blowing harder). The text-to-audio model may synthesize multiple audio signals that reflect these variations, each with subtle differences in semantic characteristics, such as pitch, tempo, timbre, tone, volume, rhythm, instrumental characteristics, effects, environmental sounds, harmonics (e.g., overtones or undertones, which may affect the richness or complexity of a sound), or articulation, which may affect how notes or sounds are connected or separated (e.g., legato, staccato). The text-to-audio model may output a set of audio signal variations based on a prompt and based on the variation parameter. The various audio signals may be combined with each other or with other audio signals to create a composite audio signal representing the soundscape of the mixed reality environment.

In some embodiments, the text-to-audio model may generate reference audio signal p₀ based on a prompt, considering elements such as sound source, direction, or environmental context (e.g., how a breeze moves through a mixed reality environment). The text-to-audio model may use a sound synthesis engine to generate realistic sounds such as wind, footsteps, or electronic device noises. The text-to-audio model may leverage pre-recorded sound libraries or physically based sound models for more complex sounds (e.g., rain, thunder, or mechanical noises). For example, the prompt “a soft breeze blowing through tall grass” may result in a generated sound that simulates a subtle, flowing wind with slight rustling of leaves and grass.

The text-to-audio model may generate multiple variations p₁, . . . , pₓ of reference audio signal p₀ based on the same prompt, where x is the total number of variation audio signals. In some embodiments, audio generation module 234 may determine total number of variation audio signals x based on one or more factors, such as type of sound associated with a prompt (e.g., continuous sound or intermittent sound), complexity of sound associated with a prompt, type of environment associated with a prompt (e.g., urban or rural; densely or sparsely populated), length of soundscape, or available system resources. For a first example, for a prompt associated with a complex or dynamic sound (e.g., a sound of a lively urban area or a dense jungle), more total number of variation audio signals x may help create a more layered, constantly evolving soundscape. For a prompt associated with a simple or steady sound (e.g., a sound of a vacant beach or an open plain), fewer total number of variation audio signals x may help create a more consistent, tranquil soundscape. For a second example, if fewer system processing or storage resources are available, then fewer total number of variation audio signals x may be determined. If more system processing or storage resources are available, then more total number of variation audio signals x may be determined.

A variation parameter (e.g., a numerical value) may be used to control how much multiple variations p₁, . . . , pₓ differ from reference audio signal p₀ or to control how similar multiple variations p₁ . . . pₓ are to reference audio signal p₀. By way of nonlimiting examples, using a variation parameter, multiple variations p₁, . . . , pₓ may differ from reference audio signal p₀ in pitch, tempo, timbre, volume, rhythm, instrumental characteristics, effects, environmental sounds, or a combination thereof. For a difference in pitch, the frequency of reference audio signal p₀ may be altered, resulting in higher or lower sounds, which may be used to create different notes. For difference in tempo, the speed at which reference audio signal p₀ is played may be varied; faster tempos may create more energetic sounds, and slower tempos may produce more relaxed or somber sounds. For difference in timbre, the quality or color of reference audio signal p₀ may be varied, which may include variations in the harmonic content, making multiple variations p₁, . . . , pₓ brighter, darker, more metallic, or more mellow. For difference in volume, the loudness of reference audio signal p₀ may be varied, creating variations in dynamics, which may be used to emphasize certain parts of the audio or to create a more nuanced soundscape. For difference in rhythm, the pattern of beats and timing of reference audio signal p₀ may be varied, leading to different rhythmic structures. For difference in instrumental characteristics, the type of an instrument or the way the instrument is played may be varied. For difference in effects, various audio effects (e.g., reverb, echo, distortion, modulation) may be applied to reference audio signal p₀ to create different textures and atmospheres in multiple variations p₁, . . . , pₓ. For difference in environmental sounds, different types of environmental sounds may be applied to reference audio signal p₀, such as changing a soft gust over a bare plain to a soft gust over tall grass. In some embodiments, a first variation parameter may be used for continuous audio signals, and a second variation parameter may be used for intermittent audio signals.

In some embodiments, the text-to-audio model may use any one or more of various techniques to vary the generated audio signals. By way of non-limiting examples, various techniques may include latent space exploration, latent space regulation, conditional generation, noise injection, parameter tuning, or feature transformation.

Using latent space exploration, the latent space may encode different features of reference audio signal p₀. By varying the parameters in the space, diverse audio signals may be generated. For example, changing a parameter may alter the pitch, tempo, or timbre of reference audio signal p₀. Using latent space regulation, constraints may be added to the latent space to ensure that variations are meaningful and semantically relevant. For example, regularizing the latent space to align with musical attributes like note range, note density, or rhythmic complexity may help generate musically coherent variations. Using conditional generation, the text-to-audio model may be conditioned on specific parameters to produce multiple variations p₁, . . . , pₓ with desired characteristics. For example, the text-to-audio model may generate multiple variations p₁, . . . , pₓ based on input parameters such as genre, mood, or instrument type. Using noise injection, controlled noise may be added to the input (e.g., reference audio signal p₀) or to the latent space to generate multiple variations p₁, . . . , pₓ. Using parameter tuning, parameters such as frequency, amplitude, or phase may be varied to produce multiple variations p₁, . . . , pₓ. The parameters may be adjusted dynamically to create diverse sounds. Using feature transformation, transformations may be applied to audio features (e.g., spectral features) to generate multiple variations p₁, . . . , pₓ. The transformations may be controlled by one or more variation parameters to produce different audio characteristics.

Using spherical interpolation, which may include spherical interpolation techniques associated with latent space exploration, a variation parameter may determine how much the generated audio signals for a prompt vary between multiple vectors or sound states. Spherical interpolation may enable interpolation between two or more sound vectors in a way that respects at least the tonal properties of the two or more sound vectors. This may ensure that the resulting audio variations remain consistent with the original prompt (e.g., “a soft breeze blowing through tall grass”) but vary in specific features, such as timbre, pitch, or intensity. By way of non-limiting example, a variation parameter v may range from 0.0 to 1.0 and may define a degree of variation. Low variation (e.g., v≈0.0) may generate variation audio signals p₁ . . . pₓ that are nearly identical to reference audio signal p₀ with minimal differences. High variation (e.g., v≈1.0) may generate variation audio signals p₁ . . . pₓ that have significant differences from reference audio signal p₀. Therefore, given the prompt “a soft breeze blowing through tall grass,” variation audio signals p₁ . . . pₓ may sound as follows: Low variation (e.g., v≈0.0) may result in variation audio signals p₁ . . . pₓ including soft breezes blowing through tall grass, with minimal differences from reference audio signal p₀. Moderate variation (e.g., v≈0.5) may result in variation audio signals p₁ . . . pₓ including soft breezes blowing through short grass, with softer, more subtle rustling sounds of grass than reference audio signal p₀. High variation (e.g., v≈1.0) may result in variation audio signals p₁ . . . pₓ including soft breezes blowing across an open plain, with a near absence of the rustling sounds of grass compared to reference audio signal p₀. In some embodiments, a first variation parameter associated with continuous sounds may be lower than a second variation parameter associated with intermittent sounds, resulting in continuous audio signals with less variation and intermittent audio signals with more variation. In some embodiments, a first variation parameter associated with continuous sounds may be higher than a second variation parameter associated with intermittent sounds, resulting in continuous audio signals with more variation and intermittent audio signals with less variation.

Mixing module 236 may be configured to take individual audio signals generated based on prompts describing the individual audio signals and perform a series of operations to normalize and spatially position the individual audio signals to create a composite audio signal.

In some embodiments, mixing module 236 may stitch multiple variations of a continuous audio signal to create a single, longer continuous audio signal for a prompt. Mixing module 236 may use various techniques—for example, crossfading, time alignment, time synchronization, amplitude matching, or frequency filtering (e.g., low-pass, high-pass, or band-pass filtering)-to remove visible or audible gaps or jumps between multiple variations of the continuous audio signal and to create a single, longer continuous audio signal for a prompt.

Mixing module 236 may normalize individual audio signals, including continuous or intermittent audio signals, to ensure the individual audio signals blend together or to prevent some audio signals from being too loud or too soft relative to others. Normalization may include volume adjustment, dynamic range control, or loudness matching. Using volume adjustment, each individual audio signal may be analyzed for its peak amplitude or RMS (Root Mean Square) value. The audio signals may be adjusted so that the audio signals are within a desired dynamic range, which may ensure that no signal dominates the overall mix while retaining the natural balance of the soundscape. Dynamic range control may be applied to prevent distortion or extreme variations in volume, which may help create a more balanced sound mix, ensuring that both soft and loud audio signals are perceptible without overpowering one another. Loudness matching may be used to adjust for perceptual loudness differences between sounds, ensuring that quieter sounds (e.g., distant birds chirping) are normalized relative to louder sounds (e.g., a nearby waterfall).

In some embodiments, to integrate an intermittent audio signal into the composite signal in a way that maintains the sporadic nature of the intermittent audio signal but also ensures the intermittent audio signal works harmoniously with continuous audio signals, mixing module 236 may use temporal placement, amplitude adjustment, timing variation, or spatial positioning. Using temporal placement, an intermittent audio signal may be placed in time relative to a continuous audio signal. By way of non-limiting example, footsteps may occur periodically within a scene where a forest breeze blows. Mixing module 236 may ensure that such transient sounds appear at appropriate moments in the auditory landscape. Using amplitude adjustment, an intermittent audio signal may be adjusted for volume relative to a continuous audio signal. By way of non-limiting example, a nearby sound (e.g., footsteps) might be louder, while a distant sound (e.g., thunder, a bird call) might be quieter. Using timing variation, an intermittent audio signal may be modified based on a randomization factor to prevent the intermittent audio signal from sounding predictable. By way of non-limiting example, the timing of bird calls could vary slightly with each playback, or a rainstorm might have raindrops that come and go at random intervals.

Using spatial positioning, mixing module 236 may spatialize intermittent audio signals to ensure the intermittent audio signals are perceived as coming from specific locations relative to a location of a user in a mixed reality environment. Intermittent audio signals may have varying frequencies, loudness, or timing (e.g., a bird call every few seconds, a car horn honking occasionally). Intermittent audio signals may also involve randomness or changes in character based on the mixed reality environment or the actions of a user. Intermittent audio signals may be linked to specific events in the environment (e.g., the sound of a door opening may happen only when a user interacts with the door). Intermittent audio signals may be unpredictable and not tied to the continuous audio signals of an environment. Therefore, in some embodiments, spatialization techniques for intermittent sounds may include instant positioning, randomization, triggering, or sharp attenuation and directionality. Unlike continuous audio signals, which may gradually change as a user moves, intermittent audio signals may be positioned immediately based on an associated event. By way of non-limiting example, a sound of a file cabinet slamming shut may be spatialized to come from the location where the slamming occurred. Using instant positioning, mixing module 236 may ensure the direction and volume of the intermittent audio signals are adjusted based on the position of the user at the time of the event. Since intermittent audio signals may often represent events (e.g., a bird singing), intermittent audio signals may benefit from randomization in timing, pitch, or volume to avoid predictability. By way of non-limiting example, a bird may chirp at random intervals. Using instant positioning, mixing module 236 may ensure intermittent audio signals are perceived as originating from the correct spatial location. The volume of intermittent audio signals may not change appreciably with distance, but the directional nature of intermittent audio signals may be crucial in providing spatial awareness to a user (e.g., footsteps from the left, an object falling to the right). Mixing module 236 may ensure intermittent audio signals are sharply attenuated or made quieter based on distance from the user. Intermittent audio signals may be often tied to user interactions or specific events in the mixed reality environment. As such, precise timing and spatial placement may be critical. When a sound occurs, mixing module 236 may use triggering to ensure an intermittent audio signal is rendered at the correct time, at the correct volume, or from the correct direction. In some embodiments, mixing module 236 may determine a plurality of positions for a plurality of intermittent audio signals within the mixed reality environment. In some aspects of the embodiments, mixing module 236 may randomize the plurality of positions for the plurality of intermittent audio signals within the mixed reality environment. In some embodiments, two or more of the plurality of intermittent audio signals may be a different radial distance from the user in the mixed reality environment, may be non-equidistant from each other, or a combination thereof.

Using spatial positioning, mixing module 236 may ensure that continuous audio signals are perceived as coming from a consistent direction or area relative to a location of a user in a mixed reality environment. As the user moves through the environment, continuous audio signals may change (e.g., in volume or timbre) based on the distance from the sound source (e.g., getting closer to a waterfall makes the sound louder and more prominent). Moreover, continuous audio signals may be influenced by environmental factors, such as room acoustics (e.g., sounds may be more reverberant in an enclosed space than outdoors). Continuous audio signals may be layered to simulate a complex environment (e.g., wind, birds, and distant sounds of traffic combined to create a dynamic outdoor atmosphere). Therefore, in some embodiments, spatialization techniques for continuous audio signals may include panning, distance-based attenuation, head-related transfer function (HRTF) techniques, and reverb or echo. In some embodiments, mixing module 236 may determine a plurality of positions for a plurality of continuous audio signals within the mixed reality environment. The continuous audio signals may be positioned at a same radial distance from a user in the mixed reality environment, and each continuous audio signal may be circumferentially equidistant from a next continuous audio signal of the plurality of continuous audio signals.

In some embodiments, mixing module 236 may implement acoustic matching in addition to spatial positioning to generate sounds of a visual scene (e.g., a mixed reality (MR) scene). Using acoustic matching, an immersive and cohesive audiovisual experience may be created to enhance the storytelling or the emotional impact of a scene. For a first example, the ability of a user to generate a sound in a physical environment (e.g., an office breakroom) and to listen back to the sound of the user in a virtual scene (e.g., a remote beach) may provide the user with a sense of realism because the sounds of the user (e.g., the voice of the user) may sound as if the voice of the user is present in the virtual scene. Using acoustic matching, if a user situated in a physical environment speaks into a microphone of a mixed reality (MR) system, then the sound of the user speaking may exhibit acoustic properties in the virtual scene such that the sound seems to originate from within the scene. For a second example, using acoustic matching, if a first user invites a second user into a scene, then a conversation between the first user and the second user may exhibit acoustic properties such that the sound seems to originate from within the scene. For a third example, using acoustic matching, sounds processed with the same acoustic transfer functions may exhibit acoustic properties such that the sounds may seem to originate from within the scene.

Using acoustic matching, the visual elements of a scene may be analyzed and key features of the scene (e.g., setting, such as indoor or outdoor, time of day, unfolding events, object materials) may be identified. Acoustic characteristics that match the visual elements may be captured by recording or synthesizing sounds (e.g., intermittent or continuous sounds). By way of nonlimiting examples, for a scene set in a forest, sounds of rustling leaves, chirping birds, or gurgling streams may be captured, and for an urban setting, car noises, foot traffic, or distant conversations may be captured. Using techniques such as adjusting reverberation, equalization, or spatial characteristics, captured sounds may be matched to the visual elements of the scene. By way of nonlimiting example, sounds in a small, enclosed room may have different reverberation characteristics from sounds in a large outdoor space. Matched sounds may be synchronized to the soundscape with the visual elements by ensuring the timing or intensity of matched sounds correspond with the actions and events of the scene. By way of nonlimiting examples, the sound of footfalls may synchronize with the movement of characters, and environmental sounds may change with visual transitions.

In some embodiments, mixing module 236 may implement acoustic matching to generate sounds for virtual visual elements of a mixed reality (MR) scene (e.g., an augmented reality (AR) scene) for which fully immersive visual scene meshes may be unavailable. Multimodal techniques may be leveraged to combine visual and audio techniques to estimate the acoustic parameters of a scene (i) by determining acoustic parameters directly from the visual elements of a scene or (ii) by estimating impulse responses of virtual or physical objects of the scene and converting to acoustic parameters. By way of nonlimiting example, multimodal techniques may be used to generate acoustics for an MR meeting room scene. By way of nonlimiting example, multimodal techniques may be implemented in an interactive software framework (e.g., a game engine) designed to facilitate the development and creation of a scene. The multimodal techniques may set acoustic parameters for acoustic simulations for a scene as a developer designs the scene, enabling the developer to introduce spatial audio in the scene (e.g., a video game scene). In some aspects of the embodiments, the developer may select an interactive element (e.g., a button, such as an “Enable acoustic matching for scene” button) to enable acoustic matching for a scene.

Mixing module 236 may combine normalized and spatialized continuous and intermittent audio signals to generate a composite audio signal that represents the soundscape of a mixed reality environment. The composite audio signal may be output as a three-dimensional (3D) audio stream that may be rendered using one or more spatial audio technologies (e.g., ambisonics, binaural audio, stereo panning) to ensure the position, distance, and intensity of the individual audio signals are preserved accurately in relation to the viewpoint of a user.

Rendering module 238 may be configured to generate spatial audio for a composite audio signal including multiple individual audio signals corresponding to discrete sound sources in a mixed reality environment. Rendering module 238 may render the composite audio signal in a manner that ensures the composite audio signal is spatially coherent with the mixed reality environment, enhancing the sense of immersion for a user. Since mixed reality environments may be dynamic and interactive, audio rendering module 238 may perform in real time, processing updates as a user moves through the environment, interacts with objects, or changes a viewpoint of the user. The composite audio signal may be generated and sent to an audio playback system (e.g., of a mixed reality headset or HMD).

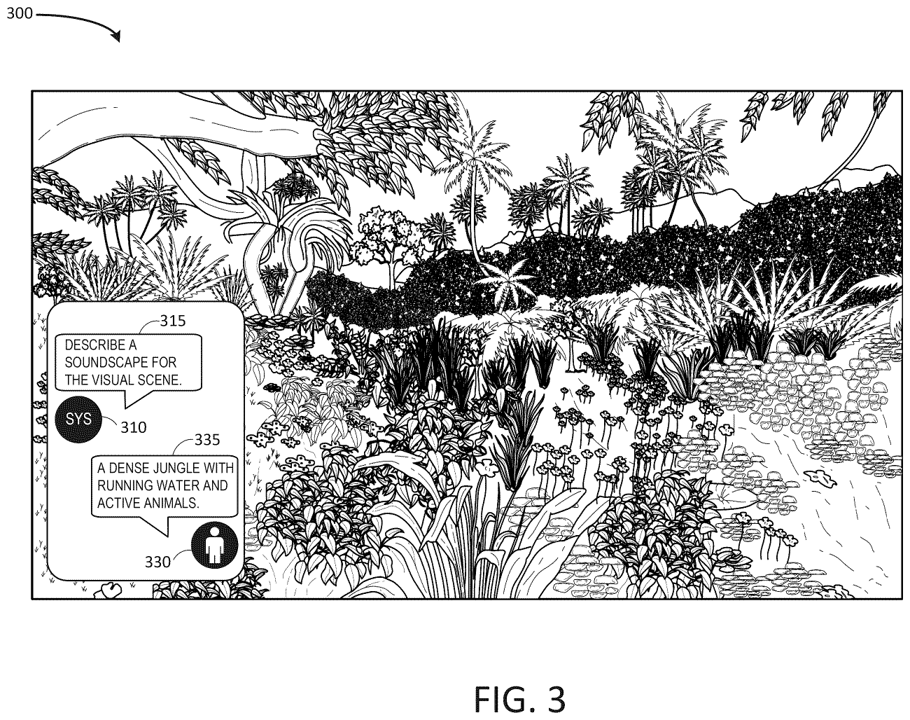

FIG. 3 illustrates an example view 300 of a mixed reality environment from a perspective of user 330 of the mixed reality environment, according to some embodiments. As shown, user 330 may be prompted by system 310 with message 315: “Describe a soundscape for the visual scene.” User 330 may provide natural language description 335 characterizing the mixed reality environment: “A dense jungle with running water and active animals.” A user may provide natural language description 335 via text, speech, or the like. Natural language description 335 may be used to generate text-based prompts for continuous or intermittent audio signals characteristic of the mixed reality environment.

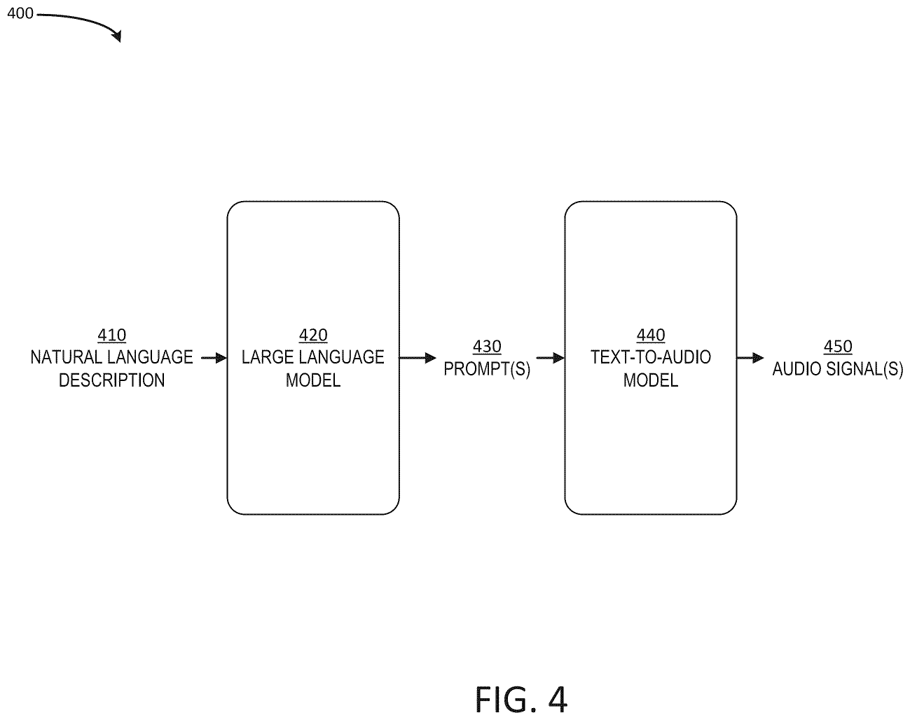

FIG. 4 illustrates steps in a process 400 for generating spatial audio from a text-based prompt describing a landscape or a soundscape of a mixed reality environment, according to some embodiments. In some embodiments, processes as disclosed herein may include one or more steps in process 400 performed by a processor circuit executing instructions stored in a memory circuit, in a client device, a remote server or a database, communicatively coupled through a network (e.g., processors 212, memories 220, client device(s) 110, server(s) 130, database 152, and network 150). In some embodiments, one or more of the steps in process 400 may be performed by a prompt generation module, an audio generation module, a mixing module, or a rendering module (e.g., prompt generation module 232, audio generation module 234, mixing module 236, or rendering module 238). In some embodiments, processes consistent with the present disclosure may include at least one or more steps as in process 400 performed in a different order, simultaneously, quasi-simultaneously, or overlapping in time.

At step 410, a natural language description of a landscape or soundscape of a mixed reality environment may be generated. A user may provide the natural language description (e.g., via text, speech, or the like). By way of non-limiting examples, the natural language description may include descriptions of audio elements or events (e.g., storm, wind, thunder, crashing waves, rustling leaves, heavy machinery) or may include descriptions of visual elements or events (e.g., mountain, beach, forest, airport terminal, roadway intersection, grocery store) of the mixed reality environment. By way of non-limiting examples, a user may specify characteristics such as time of day (e.g., morning, evening), weather (e.g., sunny, rainy, windy), or geographical location (e.g., desert, forest, city). A user may specify characteristics such as the layout of the mixed reality environment, such as distances, sizes, or relative positioning of objects and entities within the space. A user may specify actions or interactions the user expects to occur within the environment (e.g., walking near a stream, approaching a waterfall).

At step 410, a template may be populated with instructions for guiding the processing or output of an artificial intelligence (AI) model (e.g., a machine learning (ML) model, such as a large language model (LLM)). The instructions may include the natural language description provided by the user (e.g., “Afternoon in a high-tech laboratory with whirring machinery and glowing instruments”). By way of non-limiting examples, the instructions may include the following: “Provide a list of descriptions of sounds most commonly heard in an environment described by, ‘Afternoon in a high-tech laboratory with whirring machinery and glowing instruments.’” “Each description should correspond to a sound originating from a single source.” “Do not include high-pitched sounds.” “Do not include harsh sounds.” “A list of examples of sound descriptions may include ‘water current flowing, soft, gentle,’ ‘ocean waves, muffled,’ ‘flutter of bird's wings, fleeting.’” “Categorize the sound descriptions as continuous sounds or intermittent sounds.”

At step 420, a template, including the natural language description and other instructions, may be passed to a large language model (LLM). The LLM may be trained to understand and interpret complex language structures, including specific environmental and auditory cues. The LLM processes may include the following: natural language understanding, contextual interpretation, and sound category identification. Using natural language understanding, the LLM may extract key features of the natural language description, such as geographic details, dynamic activities, or environmental conditions. The LLM may understand terms related to sound sources, behaviors of sound sources, or spatial relationships within the environment (e.g., “distant thunder,” “rustling leaves,” “footsteps passing”). Using contextual interpretation, the LLM may use the environmental parameters or spatial layout to infer how such elements in the mixed reality environment (e.g., virtual or physical furniture) should interact with the generated sounds. The LLM may consider factors such as setting (e.g., indoors or outdoors), proximity (nearby or distant sounds), time-based changes (e.g., sounds changing from day to night), or weather conditions (e.g., wind affecting sound propagation). Using sound category identification, the LLM may categorize sounds based on template inputs, distinguishing between continuous sounds (e.g., a flowing river, wind in trees) and intermittent sounds (e.g., birds chirping, footsteps). The LLM may identify continuous or intermittent sound types by interpreting both the environmental context and spatial aspects.

Based on the template, the LLM may generate text-based descriptions of sounds that are commonly present in the mixed reality environment. The LLM may classify the sounds into two categories: continuous sounds and intermittent sounds. Continuous sounds may include sounds that maintain a steady presence in the mixed reality environment and do not have a defined start or end. Non-limiting examples of continuous sounds may include the following: hiss of ventilation system, hum of florescent lights, flowing stream, wind blowing across an open field, distant thunder, or rain falling on a roof. Intermittent sounds may include sounds triggered by specific actions, events, or conditions within the mixed reality environment, and may typically have a start and an end time. Non-limiting examples of intermittent sounds may include the following: beep of computer terminal, gurgling of liquid pump, birds chirping, footsteps receding, rustle of small creatures in an underbrush, distant conversation, or footsteps on gravel.

Based on the spatial layout provided by the user or interpreted by the LLM, the LLM may assign appropriate spatial attributes to each sound. For continuous or intermittent sounds, the LLM may output detailed descriptions that characterize a positioning, movement, or dynamic change of the sounds within the mixed reality environment. Spatial attributes may include directionality, distance, volume, doppler effect, or environmental interaction. Directionality may include a relative position of the sound source (e.g., left, right, behind, above). Distance may include a proximity of sound sources to the user (e.g., far-off, nearby, or at an exact location of the user). Volume may include loudness of the sound depending on the relative distance of the user to the source. Doppler effect may include adjustments to the pitch or tone of sounds as the sounds move relative to the user. Environmental interaction may include how a sound should behave in relation to other digital or physical objects (e.g., echoes off walls or the muffling effect of a forest canopy).

The LLM may output a comprehensive set of text-based descriptions of sounds associated with the mixed reality environment. The text-based descriptions may include descriptions of continuous sounds, with spatial and dynamic parameters (e.g., “a rapid river running fifty meters to the right”). The text-based descriptions may include descriptions of intermittent sounds, including timing, frequency, or user interaction cues (e.g., “footsteps of a person walking on gravel ten meters away, with a slight echo effect”).

At step 430, the set of text-based descriptions may be used as prompts for creating audio corresponding to each text-based description.

At step 440, using an AI model (e.g., an ML model, such as a text-to-audio model), a natural language prompt for an individual sound may be accepted, the prompt may be processed, and multiple variations of audio corresponding to the prompt may be generated. A variation parameter may be provided to the AI model to allow for subtle or more pronounced differences in the variation of the generated audio, depending on the value of the parameter.

At step 450, multiple variations of a reference audio signal may be generated based on the same prompt. A variation parameter (e.g., a numerical value) may be used to control how much the generated audio signals differ from one another. In some embodiments, a first variation parameter may be used for continuous audio signals, and a second variation parameter may be used for intermittent audio signals. In some embodiments, the text-to-audio model may use spherical interpolation to vary the generated audio signals. Using spherical interpolation, a variation parameter may determine how much the generated audio signals for a prompt vary between multiple vectors or sound states. Spherical interpolation may enable interpolation between two or more sound vectors in a way that respects their relative spatial and tonal properties. This may ensure that the resulting audio variations remain consistent with the original prompt but vary in specific features, such as timbre, pitch, intensity, or spatial positioning. In some embodiments, a first variation parameter associated with continuous sounds may be lower than a second variation parameter associated with intermittent sounds, resulting in continuous audio signals with less variation and intermittent audio signals with more variation.

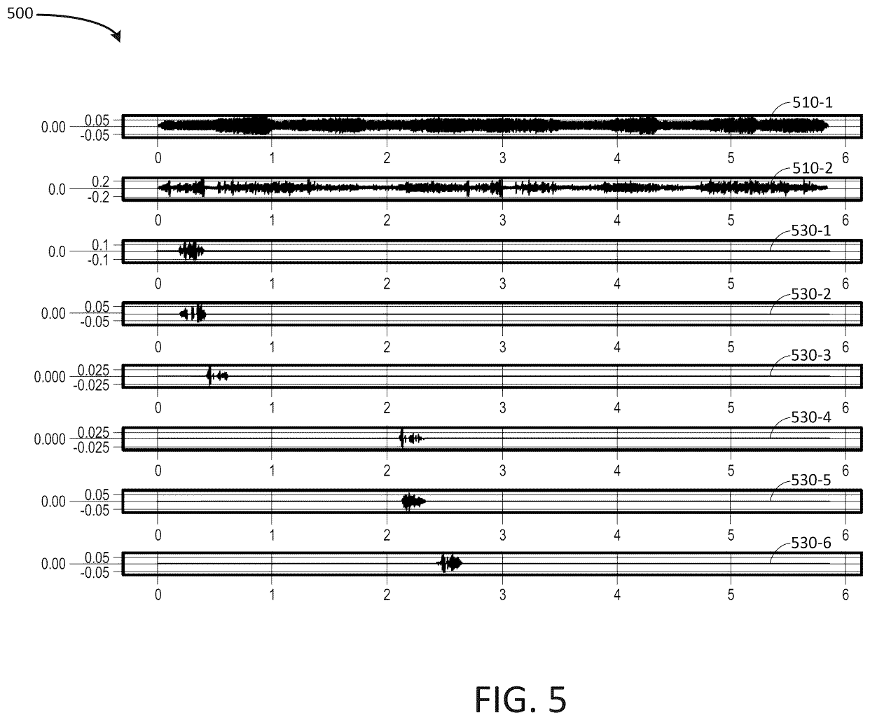

FIG. 5 illustrates example individual audio signals 500, including continuous audio signals 510 and intermittent audio signals 530, associated with a mixed reality environment, according to some embodiments. Continuous audio signals 510 include continuous audio signal 510-1 and continuous audio signal 510-2. Intermittent audio signals 530 include intermittent audio signal 530-1, intermittent audio signal 530-2, intermittent audio signal 530-3, intermittent audio signal 530-4, intermittent audio signal 530-5, and intermittent audio signal 530-6. Each audio signal is displayed on a graph including a six-second-long timeline on the x-axis and an amplitude range on the y-axis.

In some embodiments, a series of operations may be performed on individual audio signals generated based on prompts describing the individual audio signals to normalize and spatially position the individual audio signals to create a composite audio signal.

In some embodiments, multiple variations of a continuous audio signal may be stitched to create a single, longer continuous audio signal for a prompt. For example, continuous audio signal 510-1 may include multiple shorter variations of a continuous audio signal. Various techniques—including crossfading, time alignment, time synchronization, or amplitude matching—may be used to remove visible or audible gaps or jumps between the multiple shorter variations of the continuous audio signal and to create continuous audio signal 510-1, a single, longer continuous audio signal.

Individual audio signals, including continuous or intermittent audio signals, may be normalized to ensure the individual audio signals blend together or to prevent some audio signals from being too loud or too soft relative to others. Normalization may include volume adjustment, dynamic range control, or loudness matching. Using volume adjustment, each individual audio signal may be analyzed for its peak amplitude or RMS (Root Mean Square) value. The audio signals may be adjusted so that the audio signals are within a desired dynamic range, which may ensure that no signal dominates the overall mix while retaining the natural balance of the soundscape. Dynamic range control may be applied to prevent distortion or extreme variations in volume, which may help create a more balanced sound mix, ensuring that both soft and loud audio signals are perceptible without overpowering one another. Loudness matching may be used to adjust for perceptual loudness differences between sounds, ensuring that quieter sounds (e.g., distant birds chirping) are normalized relative to louder sounds (e.g., a nearby waterfall).

In some embodiments, to integrate an intermittent audio signal into the composite signal in a way that maintains the sporadic nature of the intermittent audio signal but also ensures the intermittent audio signal works harmoniously with continuous audio signals, temporal placement, amplitude adjustment, timing variation, or spatial positioning may be used. Using temporal placement, an intermittent audio signal may be placed in time relative to a continuous audio signal. By way of non-limiting example, footsteps may occur periodically within a scene where a forest breeze blows. Temporal placement may ensure that such transient sounds appear at appropriate moments in the auditory landscape. Using amplitude adjustment, an intermittent audio signal may be adjusted for volume relative to a continuous audio signal. By way of non-limiting example, a nearby sound (e.g., footsteps) might be louder, while a distant sound (e.g., thunder, a bird call) might be quieter. Using timing variation, an intermittent audio signal may be modified based on a randomization factor to prevent the intermittent audio signal from sounding predictable. By way of non-limiting example, the timing of bird calls could vary slightly with each playback, or a rainstorm might have raindrops that come and go at random intervals.

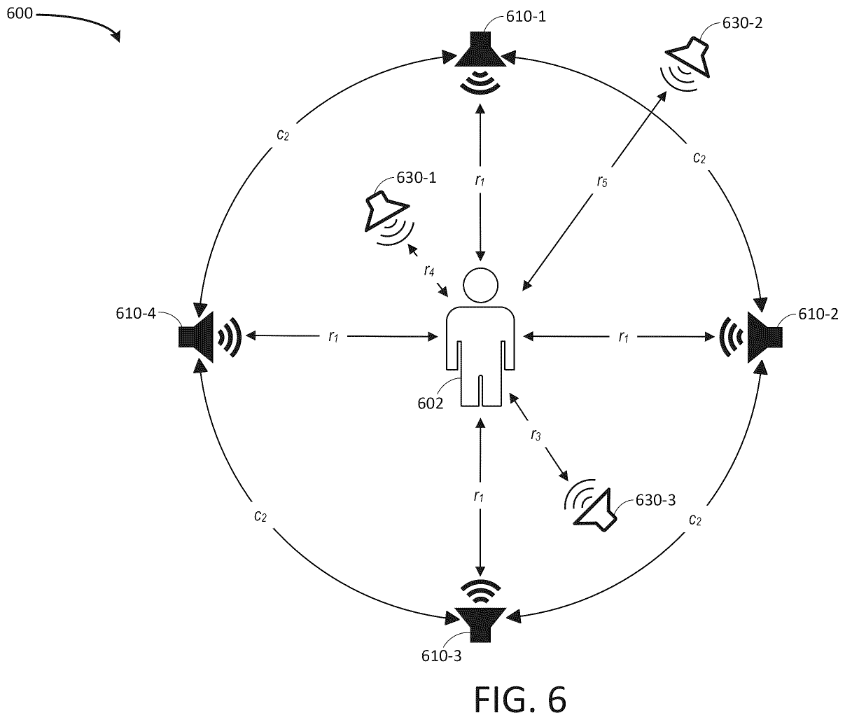

FIG. 6 illustrates example positionings 600 of continuous audio signals 610 and intermittent audio signals 630 in a mixed reality environment, according to some embodiments. Continuous audio signals 610 may include continuous audio signal 610-1, continuous audio signal 610-2, continuous audio signal 610-3, and continuous audio signal 610-4. Intermittent audio signals 630 may include intermittent audio signal 630-1, intermittent audio signal 630-2, and intermittent audio signal 630-3.

Using spatial positioning, intermittent audio signals 630 may be spatialized to ensure intermittent audio signals 630 are perceived as coming from specific locations relative to a location of user 602 in a mixed reality environment. Intermittent audio signals 630 may have varying frequencies, loudness, or timing (e.g., a bird call every few seconds, a car horn honking occasionally). Intermittent audio signals 630 may also involve randomness or changes in character based on the mixed reality environment or the actions of a user. Intermittent audio signals 630 may be often linked to specific events in the environment (e.g., the sound of a door opening may happen only when a user interacts with the door). Intermittent audio signals 630 may be often unpredictable and not tied to the continuous audio signals of an environment. Therefore, in some embodiments, spatialization techniques for intermittent sounds may include instant positioning, randomization, triggering, or sharp attenuation and directionality. Unlike continuous audio signals 610, which may gradually change as user 602 moves, intermittent audio signals 630 may be positioned immediately based on an associated event. By way of non-limiting example, a sound of a file cabinet slamming shut may be spatialized to come from the location where the slamming occurred. Using instant positioning, it may be ensured that the direction and volume of intermittent audio signals 630 are adjusted based on the position of user 602 at the time of the event. Since intermittent audio signals often represent events (e.g., a bird singing), intermittent audio signals 630 may benefit from randomization in timing, pitch, or volume to avoid predictability. By way of non-limiting example, a bird may chirp at random intervals. Using instant positioning, it may be ensured that intermittent audio signals 630 are perceived as originating from the correct spatial location. The volume of intermittent audio signals 630 may not change appreciably with distance, but the directional nature of intermittent audio signals may be crucial in providing spatial awareness to user 602 (e.g., footsteps from the left, an object falling to the right). It may be ensured intermittent audio signals 630 are sharply attenuated or made quieter based on distance from user 602. Intermittent audio signals 630 may be often tied to user interactions or specific events in the mixed reality environment. As such, precise timing and spatial placement may be critical. When a sound occurs, triggering may be used to ensure intermittent audio signals 630 are rendered at the correct times, at the correct volumes, and from the correct directions. In some embodiments, a plurality of positions for intermittent audio signals 630 within the mixed reality environment may be determined. In some aspects of the embodiments, the plurality of positions for the plurality of intermittent audio signals within the mixed reality environment may be randomized. In some embodiments, two or more of the plurality of intermittent audio signals 630 may be a different radial distance from user 602 in the mixed reality environment, may be non-equidistant from each other, or a combination thereof. For example, as shown in FIG. 6, intermittent audio signal 630-1 is radial distance r₄ from user 602, intermittent audio signal 630-2 is radial distance r₅ from user 602, and intermittent audio signal 630-3 is radial distance r₃ from user 602, wherein r₃≠r₄≠r₅. Using spatial positioning, continuous audio signals 610 may be spatialized to ensure that continuous audio signals 610 are perceived as coming from a consistent direction or area relative to a location of user 602 in a mixed reality environment. As user 602 moves through the environment, continuous audio signals may change (e.g., in volume or timbre) based on the distance from the sound source (e.g., getting closer to a waterfall makes the sound louder and more prominent). Moreover, continuous audio signals 610 may be influenced by environmental factors, such as room acoustics (e.g., sounds may be more reverberant in an enclosed space than outdoors). Continuous audio signals 610 may be layered to simulate a complex environment (e.g., wind, birds, and distant sounds of traffic combined to create a dynamic outdoor atmosphere). Therefore, in some embodiments, spatialization techniques for continuous audio signals may include panning, distance-based attenuation, head-related transfer function (HRTF) techniques, and reverb or echo. In some embodiments, a plurality of positions for continuous audio signals 610 within the mixed reality environment may be determined. Continuous audio signals 610 may be positioned at a same radial distance from user 602 in the mixed reality environment, and each continuous audio signal may be circumferentially equidistant from a next continuous audio signal. For example, as shown in FIG. 6, continuous audio signals 610-1, 610-2, 610-3, and 610-4 are each radial distance r₁ from user 602. Also, as shown in FIG. 6, continuous audio signal 610-1 is circumferential distance c₂ from 610-2, which is circumferential distance c₂ from 610-3, which is circumferential distance c₂ from 610-4, which is circumferential distance c₂ from 610-1.

Normalized and spatialized continuous and intermittent audio signals may be combined to generate a composite audio signal that represents the soundscape of a mixed reality environment. The composite audio signal may be output as a three-dimensional (3D) audio stream that may be rendered using one or more spatial audio technologies (e.g., ambisonics, binaural audio, stereo panning) to ensure the position, distance, and intensity of the individual audio signals are preserved accurately in relation to the viewpoint of a user (e.g., user 602).

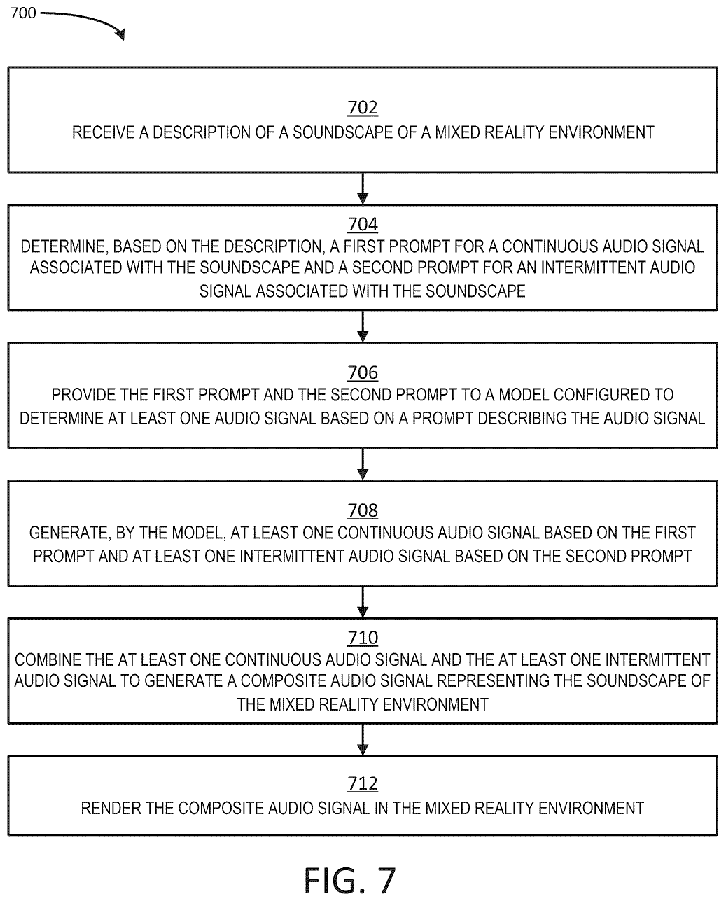

FIG. 7 is a flowchart illustrating operations in a method 700 for generating spatial audio from a text-based prompt describing a landscape or a soundscape of a mixed reality environment, according to some embodiments. In some embodiments, processes as disclosed herein may include one or more operations in method 700 performed by a processor circuit executing instructions stored in a memory circuit, in a client device, a remote server or a database, communicatively coupled through a network (e.g., processors 212, memories 220, client device(s) 110, server(s) 130, database 152, and network 150). In some embodiments, one or more of the operations in method 700 may be performed by a prompt generation module, an audio generation module, a mixing module, or a rendering module (e.g., prompt generation module 232, audio generation module 234, mixing module 236, or rendering module 238). In some embodiments, processes consistent with the present disclosure may include at least one or more operations as in method 700 performed in a different order, simultaneously, quasi-simultaneously, or overlapping in time.

Operation 702 may include receiving a description of a soundscape of a mixed reality environment. In some embodiments, the description of the soundscape may include a text-based input provided by a user. In some embodiments, an avatar of a user may be included in the mixed reality environment.

Operation 704 may include determining, based on the description, a first prompt for a continuous audio signal associated with the soundscape and a second prompt for an intermittent audio signal associated with the soundscape. In further aspects of the embodiments, operation 704 may include providing the description of the soundscape to a large language model (LLM) configured to determine a prompt for an audio signal associated with a soundscape. In some embodiments, the first prompt for the continuous audio signal associated with the soundscape may include a first text-based output of the LLM, and the second prompt for the intermittent audio signal associated with the soundscape may include a second text-based output of the LLM. In some embodiments, determining the first prompt and the second prompt may include generating, by the LLM, the first prompt and the second prompt.

Operation 706 may include providing the first prompt and the second prompt to a model configured to determine at least one audio signal based on a prompt describing the audio signal. In further aspects of the embodiments, operation 706 may include determining a first variation parameter associated with the first prompt, and determining a second variation parameter associated with the second prompt. In some embodiments, the at least one continuous audio signal may include a plurality of continuous audio signals, and generating the at least one continuous audio signal may include generating, based on the first variation parameter, the plurality of continuous audio signals. In some embodiments, the at least one intermittent audio signal may include a plurality of intermittent audio signals, and generating the at least one intermittent audio signal may include generating, based on the second variation parameter, the plurality of intermittent audio signals. Operation 708 may include generating, by the model, at least one continuous audio signal based on the first prompt and at least one intermittent audio signal based on the second prompt.

Operation 710 may include combining the at least one continuous audio signal and the at least one intermittent audio signal to generate a composite audio signal representing the soundscape of the mixed reality environment. In some embodiments, the at least one continuous audio signal may include a plurality of continuous audio signals, and the at least one intermittent audio signal may include a plurality of intermittent audio signals. In further aspects of the embodiments, operation 710 may include determining a first plurality of positions for the plurality of continuous audio signals within the mixed reality environment. The plurality of continuous audio signals may be a same radial distance from a user in the mixed reality environment, and each continuous audio signal of the plurality of continuous audio signals may be circumferentially equidistant from a next continuous audio signal of the plurality of continuous audio signals. In further aspects of the embodiments, operation 710 may include determining a second plurality of positions for the plurality of intermittent audio signals within the mixed reality environment. Two or more of the plurality of intermittent audio signals may be a different radial distance from the user in the mixed reality environment and may be non-equidistant from each other. Operation 712 may include rendering the composite audio signal in the mixed reality environment.

### Hardware Overview

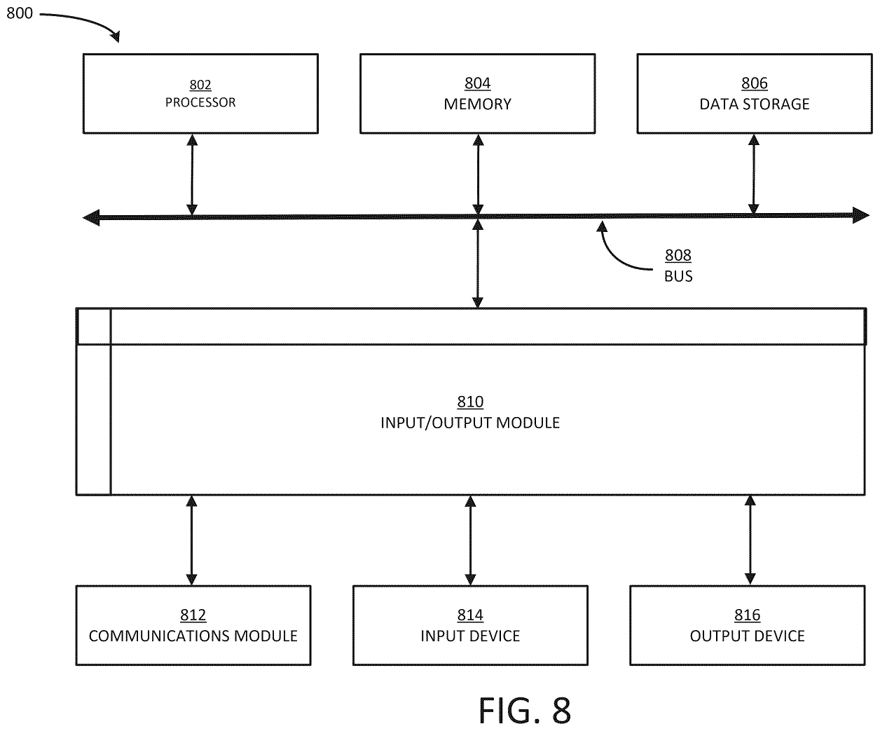

FIG. 8 is a block diagram illustrating an exemplary computer system 800 with which client devices, and the steps or operations in FIGS. 4 and 7, may be implemented, according to some embodiments. In certain aspects, the computer system 800 may be implemented using hardware or a combination of software and hardware, either in a dedicated server, or integrated into another entity, or distributed across multiple entities.

Computer system 800 (e.g., client device(s) 110 and server(s) 130) may include bus 808 or another communication mechanism for communicating information, and a processor 802 (e.g., processors 212) coupled with bus 808 for processing information. By way of example, computer system 800 may be implemented with one or more processors 802. Processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that may perform calculations or other manipulations of information.

Computer system 800 may include, in addition to hardware, code that creates an execution environment for the computer program in question, e.g., code that constitutes processor firmware, a protocol stack, a database management system, an operating system, or a combination of one or more of them stored in an included memory 804 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. Processor 802 and the memory 804 may be supplemented by, or incorporated in, special purpose logic circuitry.

The instructions may be stored in memory 804 and implemented in one or more computer program products, e.g., one or more modules of computer program instructions encoded on a computer-readable medium for execution by, or to control the operation of, computer system 800, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 804 may also be used for storing temporary variable or other intermediate information during execution of instructions to be executed by processor 802.

A computer program as discussed herein does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one computer or on multiple computers that may be located at one site or distributed across multiple sites and interconnected by a communication network. The processes and logic flows described in this specification may be performed by one or more programmable processors executing one or more computer programs to perform functions by operating on input data and generating output.

Computer system 800 further includes a data storage device 806 such as a magnetic disk or optical disk, coupled to bus 808 for storing information and instructions. Computer system 800 may be coupled via input/output module 810 to various devices. Input/output module 810 may be any input/output module. Exemplary input/output modules 810 include data ports such as Universal Serial Bus (USB) ports. The input/output module 810 may be configured to connect to a communications module 812. Exemplary communications modules 812 (e.g., communications modules 218) include networking interface cards, such as Ethernet cards and modems. In certain aspects, input/output module 810 may be configured to connect to a plurality of devices, such as an input device 814 (e.g., input device 214) and/or an output device 816 (e.g., output device 216). Exemplary input devices 814 include a keyboard and a pointing device, e.g., a mouse or a trackball, by which a user may provide input to computer system 800. Other kinds of input devices 814 may be used to provide for interaction with a user as well, such as a tactile input device, visual input device, audio input device, or brain-computer interface device. For example, feedback provided to the user may be any form of sensory feedback, e.g., visual feedback, auditory feedback, or tactile feedback; and input from the user may be received in any form, including acoustic, speech, tactile, or brain wave input. Exemplary output devices 816 include display devices, such as an LCD (liquid crystal display) monitor, for displaying information to the user.

According to one aspect of the present disclosure, client device(s) 110 and server(s) 130 may be implemented using computer system 800 in response to processor 802 executing one or more sequences of one or more instructions contained in memory 804. Such instructions may be read into memory 804 from another machine-readable medium, such as data storage device 806. Execution of the sequences of instructions contained in memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification may be implemented in a computing system that includes a back-end component, e.g., a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. The communication network (e.g., network 150) may include, for example, any one or more of a LAN, a WAN, the Internet, and the like. Further, the communication network may include, but is not limited to, for example, any one or more of the following tool topologies, including a bus network, a star network, a ring network, a mesh network, a star-bus network, tree or hierarchical network, or the like. The communications modules may be, for example, modems or Ethernet cards.

Computer system 800 may include clients and servers. A client and server may be generally remote from each other and typically interact through a communication network. The relationship of client and server arises by virtue of computer programs running on the respective computers and having a client-server relationship to each other. Computer system 800 may be, for example, and without limitation, a desktop computer, laptop computer, or tablet computer. Computer system 800 may also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 802 for execution. Such a medium may take many forms, including, but not limited to, non-volatile media, volatile media, and transmission media. Non-volatile media include, for example, optical or magnetic disks, such as data storage device 806. Volatile media include dynamic memory, such as memory 804. Transmission media include coaxial cables, copper wire, and fiber optics, including the wires forming bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer may read. The machine-readable storage medium may be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

### General Notes on Terminology

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The subject matter of this specification has been described in terms of particular aspects, but other aspects may be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims may be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems may generally be integrated together in a single software product or packaged into multiple software products. Other variations are within the scope of the following claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user. Method clauses may be provided to present elements of the various steps, operations, or processes in a sample order, and are not meant to be limited to the specific order or hierarchy presented.

Although illustrative embodiments have been shown and described, a wide range of modification, change, and substitution are contemplated in the foregoing disclosure and in some instances, some features of the embodiments may be employed without a corresponding use of other features. Those of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A computer-implemented method for audio generation in mixed reality environments, comprising:
receiving a description of a soundscape of a mixed reality environment;
determining, based on the description, a first prompt for a continuous audio signal associated with the soundscape and a second prompt for an intermittent audio signal associated with the soundscape;
providing the first prompt and the second prompt to a model configured to determine at least one audio signal based on a prompt describing the audio signal;
generating, by the model, at least one continuous audio signal based on the first prompt and at least one intermittent audio signal based on the second prompt;
combining the at least one continuous audio signal and the at least one intermittent audio signal to generate a composite audio signal representing the soundscape of the mixed reality environment; and
rendering the composite audio signal in the mixed reality environment.

2. The computer-implemented method of claim 1, wherein the description of the soundscape comprises a text-based input provided by a user.

3. The computer-implemented method of claim 1, further comprising:
providing the description of the soundscape to a large language model (LLM) configured to determine a prompt for an audio signal associated with a soundscape.

4. The computer-implemented method of claim 3, wherein:
the first prompt for the continuous audio signal associated with the soundscape includes a first text-based output of the LLM; and
the second prompt for the intermittent audio signal associated with the soundscape includes a second text-based output of the LLM.

5. The computer-implemented method of claim 3, wherein determining the first prompt and the second prompt includes generating, by the LLM, the first prompt and the second prompt.

6. The computer-implemented method of claim 1, further comprising:
determining a first variation parameter associated with the first prompt; and
determining a second variation parameter associated with the second prompt.

7. The computer-implemented method of claim 6, wherein:
the at least one continuous audio signal includes a plurality of continuous audio signals; and
generating the at least one continuous audio signal includes generating, based on the first variation parameter, the plurality of continuous audio signals.

8. The computer-implemented method of claim 6, wherein:
the at least one intermittent audio signal includes a plurality of intermittent audio signals; and
generating the at least one intermittent audio signal includes generating, based on the second variation parameter, the plurality of intermittent audio signals.

9. The computer-implemented method of claim 1, wherein:
the at least one continuous audio signal includes a plurality of continuous audio signals; and
the at least one intermittent audio signal includes a plurality of intermittent audio signals.

10. The computer-implemented method of claim 9, further comprising:
determining a first plurality of positions for the plurality of continuous audio signals within the mixed reality environment, wherein the plurality of continuous audio signals are a same radial distance from a user in the mixed reality environment, and wherein each continuous audio signal of the plurality of continuous audio signals is circumferentially equidistant from a next continuous audio signal of the plurality of continuous audio signals; and
determining a second plurality of positions for the plurality of intermittent audio signals within the mixed reality environment, wherein two or more of the plurality of intermittent audio signals are a different radial distance from the user in the mixed reality environment and are non-equidistant from each other.

11. A system, comprising:
one or more processors; and
a memory storing instructions that, when executed by the one or more processors, cause the system to perform operations including:
receiving a description of a soundscape of a mixed reality environment;
determining, based on the description, a first prompt for a continuous audio signal associated with the soundscape and a second prompt for an intermittent audio signal associated with the soundscape;
providing the first prompt and the second prompt to a model configured to determine at least one audio signal based on a prompt describing the audio signal;
generating, by the model, at least one continuous audio signal based on the first prompt and at least one intermittent audio signal based on the second prompt;
combining the at least one continuous audio signal and the at least one intermittent audio signal to generate a composite audio signal representing the soundscape of the mixed reality environment; and
rendering the composite audio signal in the mixed reality environment.

12. The system of claim 11, wherein the description of the soundscape comprises a text-based input provided by a user.

13. The system of claim 11, wherein the operations further comprise:
providing the description of the soundscape to a large language model (LLM) configured to determine a prompt for an audio signal associated with a soundscape.

14. The system of claim 13, wherein:
the first prompt for the continuous audio signal associated with the soundscape includes a first text-based output of the LLM;
the second prompt for the intermittent audio signal associated with the soundscape includes a second text-based output of the LLM; and
determining the first prompt and the second prompt includes generating, by the LLM, the first prompt and the second prompt.

15. The system of claim 11, wherein the operations further comprise:
determining a first variation parameter associated with the first prompt; and
determining a second variation parameter associated with the second prompt.

16. The system of claim 15, wherein:
the at least one continuous audio signal includes a plurality of continuous audio signals; and
generating the at least one continuous audio signal includes generating, based on the first variation parameter, the plurality of continuous audio signals.

17. The system of claim 15, wherein:
the at least one intermittent audio signal includes a plurality of intermittent audio signals; and
generating the at least one intermittent audio signal includes generating, based on the second variation parameter, the plurality of intermittent audio signals.

18. The system of claim 11, wherein:
the at least one continuous audio signal includes a plurality of continuous audio signals; and
the at least one intermittent audio signal includes a plurality of intermittent audio signals.

19. The system of claim 18, wherein the operations further comprise:
determining a first plurality of positions for the plurality of continuous audio signals within the mixed reality environment, wherein the plurality of continuous audio signals are a same radial distance from a user in the mixed reality environment, and wherein each continuous audio signal of the plurality of continuous audio signals is circumferentially equidistant from a next continuous audio signal of the plurality of continuous audio signals; and
determining a second plurality of positions for the plurality of intermittent audio signals within the mixed reality environment, wherein two or more of the plurality of intermittent audio signals are a different radial distance from the user in the mixed reality environment and are non-equidistant from each other.

20. A non-transitory computer-readable storage medium storing instructions encoded thereon that, when executed by a processor, cause the processor to perform operations comprising:
receiving a description of a soundscape of a mixed reality environment;
determining, based on the description, a first prompt for a continuous audio signal associated with the soundscape and a second prompt for an intermittent audio signal associated with the soundscape;
determining a first variation parameter associated with the first prompt and a second variation parameter associated with the second prompt;
providing the first prompt, the second prompt, the first variation parameter, and the second variation parameter to a model configured to determine at least one audio signal based on a prompt describing the audio signal;
generating, by the model, a plurality of continuous audio signals based on the first prompt and the first variation parameter, and a plurality of intermittent audio signals based on the second prompt and the second variation parameter;
combining the plurality of continuous audio signals and the plurality of intermittent audio signals to generate a composite audio signal representing the soundscape of the mixed reality environment;
determining a first plurality of positions for the plurality of continuous audio signals within the mixed reality environment, wherein the plurality of continuous audio signals are a same radial distance from a user in the mixed reality environment, and wherein each continuous audio signal of the plurality of continuous audio signals is circumferentially equidistant from a next continuous audio signal of the plurality of continuous audio signals;
determining a second plurality of positions for the plurality of intermittent audio signals within the mixed reality environment, wherein two or more of the plurality of intermittent audio signals are a different radial distance from the user in the mixed reality environment and are non-equidistant from each other; and
rendering, based on the first plurality of positions and the second plurality of positions, the composite audio signal in the mixed reality environment.
